(19) United States
(12) Patent Application Publication
(10) Pub. No.: US 2016/0196024 A1
(43) Pub. Date: Jul. 7, 2016

(54) APPARATUS AND METHOD FOR PROVIDING INFORMATION BASED ON PRESENCE OR ABSENCE OF USER INPUT

(71) Applicant: INNOSPARK INC., Seoul (KR)

(72) Inventor: Jaechan SHIN, Gyeonggi-do (KR)

(73) Assignee: INNOSPARK INC., Seoul (KR)

(21) Appl. No.: 14/963,254

(22) Filed: Dec. 9, 2015

(30) Foreign Application Priority Data
Dec. 10, 2014 (KR) 10-2014-0177690

(51) Int. Cl. G06F 3/0484

(52) U.S. Cl. CPC G06F 3/0484

(57) ABSTRACT

An apparatus and method for providing information based on the presence or absence of a user input are provided. The apparatus includes a user input recognizer configured to recognize a user input, and a controller configured to, if a user input is not recognized for a predetermined time, control an output unit to output predetermined information.

### CROSS-REFERENCE TO RELATED PATENT APPLICATION

This application claims the benefit of Korean Patent Application No. 10-2014-0177690, filed on Dec. 10, 2014, which is hereby incorporated by reference as if fully set forth herein.

### BACKGROUND OF THE INVENTION

1. Field of the Invention

The present disclosure relates generally to an apparatus and a method for providing information based on the presence or absence of a user input, and more particularly, to an apparatus and method for providing information, in which in the absence of a user input for a predetermined time, predetermined information is output.

2. Discussion of the Related Art

Along with the development of electronic technology and communication technology, techniques based on wireless communication technology have recently been used widely in all industrial fields including a service field as well as a communication field. Therefore, a variety of services are provided through a wireless communication network, inclusive of voice call, data transmission, the Internet, and virtual space.

These services based on a wireless communication network are also widespread in the field of advertisement. For example, a banner advertisement is provided or an advertisement is exposed in a part of an on-going application.

However, if a user wants to concentrate on a task such as a game without interruptions, such an advertisement may be annoying and intrusive because it is unwanted on the side of the user. Moreover, if the user blocks advertisements by a setting, this means loss to an advertiser.

### SUMMARY OF THE INVENTION

Accordingly, the present invention is directed to an apparatus and method for providing information based on the presence or absence of a user input that substantially obviate one or more problems due to limitations and disadvantages of the related art.

An aspect of the present invention is to provide predetermined information to a user using a value related to a time during which there is no user input.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the object and other advantages and in accordance with the purpose of an aspect of the invention, as embodied and broadly described herein, an apparatus for providing information based on the presence or absence of a user input includes a user input recognizer configured to recognize a user input, and a controller configured to, if a user input is not recognized for a predetermined time, control an output unit to output predetermined information.

The output unit may include at least one of a speaker, a display, and a vibrator.

The apparatus may further include the output unit.

The predetermined information may include an advertisement or additional information about an application being executed in the apparatus.

The user input recognizer may include at least one of a touch screen, a touchpad, a physical button, an accelerometer, and a gyro sensor, to receive the user input.

If a user input for an application being executed is not recognized, the controller may control output of the predetermined information to a part of an area in which the application is being executed.

The application being executed in the apparatus may be a game.

Upon recognition of a user input while the predetermined information is output, the controller may discontinue outputting the predetermined information.

According to another aspect of the present invention, a method for providing information based on the presence or absence of a user input includes recognizing a user input using a sensor, and if a user input is not recognized for a predetermined time, controlling an output unit to output predetermined information.

The outputting of predetermined information may include outputting the predetermined information using at least one of a speaker, a display, and a vibrator.

The predetermined information may include an advertisement or additional information about an application being executed in an apparatus.

The controlling of the output unit may include, if a user input for an application being executed is not recognized, controlling output of the predetermined information to a part of an area in which the application is being executed.

The method may further include, upon recognition of a user input while the predetermined information is output, discontinuing outputting the predetermined information.

According to another aspect of the present invention, a computer program may include a command to perform the method for providing information based on the presence or absence of a user input.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an apparatus 1 for providing information based on the presence or absence of a user input according to an embodiment of the present invention;

FIG. 2 illustrates a state in which predetermined information is output according to an embodiment of the present invention; and

FIG. 3 is a flowchart illustrating a method for providing information based on the presence or absence of a user input according to an embodiment of the present invention.

### DETAILED DESCRIPTION OF THE INVENTION

A detailed description of the present invention is given below with reference to the attached drawings illustrating exemplary specific embodiments of the present invention. These embodiments are described in detail so that those skilled in the art may implement the present invention. It is to be understood that although various embodiments of the present invention are different, they do not need to be mutually exclusive. For example, a specific shape, structure, and feature according to an embodiment, disclosed in the present specification may be realized in another embodiment within the scope and spirit of the present invention. Further, it is to be understood that the positions or layout of individual components in each embodiment may be modified without departing from the scope and spirit of the present invention. Accordingly, the following detailed description is not intended to be restrictive, and the scope of the present invention should be determined by the appended claims and their legal equivalents. Like reference numerals denote the same or similar functions in a plurality of aspects.

The embodiments disclosed in the present invention may have implemented fully in hardware, partially in hardware and partially in software, or fully in software. The term as used herein, ‘unit’, ‘module’, ‘device’, or ‘system’ refers to a computer-related entity such as hardware, a combination of hardware and software, or software. For example, a unit, a module, a device, or a system may be, but not limited to, an on-going process, a processor, an object, an executable file, a threshold of execution, a program, and/or a computer in the present disclosure. For example, both an ongoing application executed in a computer and the computer may correspond to a unit, a module, a device, or a system.

The embodiments are described with reference to the illustrated flowcharts. While the methods are illustrated and described in block forms, for simplicity of description, the present invention is not limited to the sequence of the blocks. Some blocks and other blocks may take place simultaneously or in a different order from that illustrated and described in the present disclosure, and various other branches, flow paths, and block orders may be achieved, for the same or similar results. Also, all blocks shown for implementation of the methods described in the present disclosure may not be required. Further, a method according to an embodiment of the present invention may be implemented in the form of a computer program for executing a series of steps and the computer program may be recorded to a computer-readable recording medium.

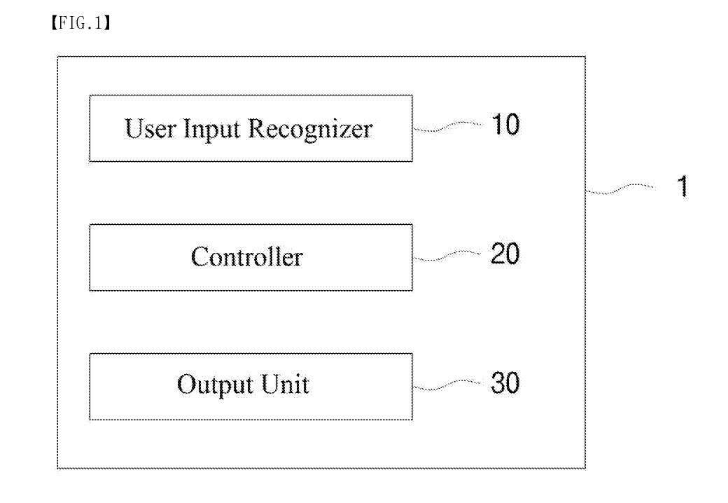

FIG. 1 is a block diagram illustrating an interior configuration of an apparatus 1 for providing information based on the presence or absence of a user input (hereinafter, shortly referred to as an information providing apparatus 1) according to an embodiment of the present invention. The information providing apparatus 1 may include a user input recognizer 10 for recognizing a user input, and a controller 20 for controlling an output unit 30 to output predetermined information, when a user input is not recognized for a predetermined time. In another embodiment, the information providing apparatus 1 may further include the output unit 30.

The information providing apparatus 1 may be implemented in various manners and include various features. The information providing apparatus 1 may include, but not limited to, any device that plays a specific game or executes a specific application.

An application, that is, a program may be executed in the information providing apparatus 1, using a storage function, a computation function, etc. of the information providing apparatus 1. For example, the information providing apparatus 1 may include any handheld wireless terminal such as a Personal Communication System (PCS) terminal, a Global System for Mobile communications (GSM) terminal, a Personal Digital Cellular (PDC) terminal, a Personal Handyphone System (PHS) terminal, a Personal Digital Assistant (PDA), and an International Mobile Telecommunication-2000 (IMT-2000) terminal. Particularly, the information providing apparatus 1 may be a smartphone which includes a display, various sensors such as a touch sensor, a vibration motor, a speaker, and a communication module. Under circumstances, the information providing apparatus 1 may be a small-size smart pad, a computer, or a server. Further, the information providing apparatus 1 may include a processing system with a processor, an Operating System (OS), and an Application Programming Interface (API), for providing communication between one or more software applications and the OS. The processing system of the information providing apparatus 1 may also be configured to execute various software applications.

The information providing apparatus 1 may communicate with another object. For this purpose, hardware or software may be loaded in the information providing apparatus 1. The communication may be conducted in conformance to any communication scheme that enables networking of objects, not limited to wired/wireless communication, 3^{rd} Generation (3G) communication, 4^{th} Generation (4G) communication, or any other communication scheme. All transmittable/receivable information including various sensor information, voice feedback information, and vibration feedback information in the information providing apparatus 1 may be transmitted to an external object or an internal component. The communication may be conducted according to, but not limited to, one or more communication schemes selected from a group of Wireless Local Area Network (WLAN), Metropolitan Area Network (MAN), Global System for Mobile communication (GSM), Enhanced Data GSM Environment (EDGE), High Speed Downlink Packet Access (HSDPA), Wideband Code Division Multiple Access (WCDMA), CDMA, Time Division Multiple Access (TDMA), Bluetooth, Zigbee, Wireless Fidelity (Wi-Fi), Voice over Internet Protocol (VoIP), Long Term Evolution (LTE)-Advanced (LTE-A), Mobile Worldwide Interoperability for Microwave Access (Mobile WiMAX) (IEEE 802.16e), UMB (formerly EV-DO Rev, C), Flash-Orthogonal Frequency Division Multiplexing (Flash-OFDM), iBurst and Mobile Broadband Wireless Access (MBWA) (IEEE 802.20), HIPERMAN, Beam Division Multiple Access (BDMA), WiMAX, and ultrasonic communication.

The OS of the information providing apparatus 1 may be, but not limited to, Android of Google, Blackberry of RIM, iOS of Apple, Symbian of Nokia, Windows Mobile of Microsoft, or Bada of Samsung Electronics.

A display (not shown) may receive a touch input of a user in the information providing apparatus 1. In an embodiment, the touch input may be applied in the form of a state such as the position of a touched point, a new point, a moved point, a released point, and the like, or a touch gesture such as tab, double tab, panning, flicking, drag and drop, pinching, stretching, and the like.

The display may be a Liquid Crystal Display (LCD), a Plasma Display Panel (PDP) display, or a projector display in the information providing apparatus 1. The display may include a Three-Dimensional (3D) display based on autostereography like a shutter glasses scheme, a lenticular scheme, and a parallax barrier scheme, or using a hologram. Also, a Light Emitting Diode (LED), an Organic LED (OLED), a Light Emitting Polymer (LEP), an Electro-Luminescence Element (EL Element), a Field Emission Display (FED), or a Polymer LED (PLED) may be applied to the display.

The output unit 30 may be one or more of a speaker, a display, and a vibrator. That is, the output unit 30 may include any device capable of providing predetermined information to a user in a visual, audible, or haptic manner. While not shown, the information providing device 1 may include a memory for storing various types of data. Besides the afore-described functions, the controller 20 may control an operation of the information providing apparatus 1, while exchanging data with any component of the information providing apparatus 1.

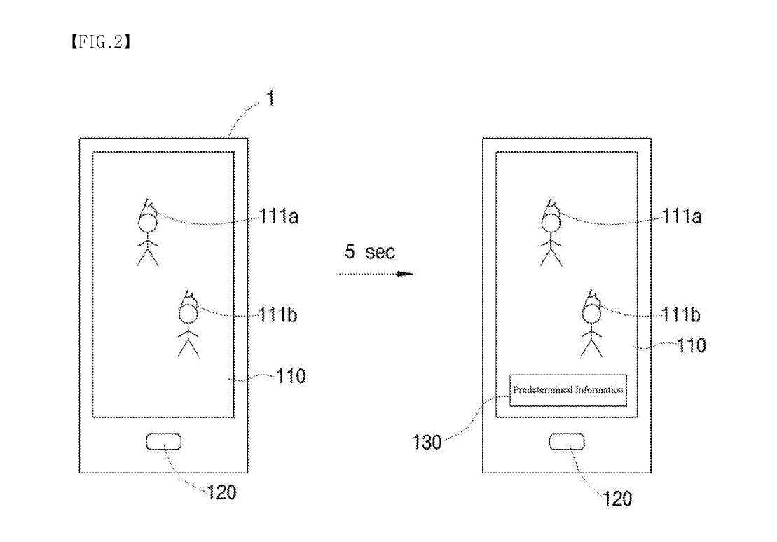

FIG. 2 illustrates a state in which predetermined information is output according to an embodiment of the present invention. Referring to FIG. 2, a specific application is being executed on a display 110. For example, the application may be, but not limited to, a game. The following description will be given in the context of the application being a game, by way of example.

If there is no user input for a predetermined time while game characters 111a and 111b are displayed on the display 110 and a game is played, the controller 20 may control the output unit 30 to output predetermined information 130. While the predetermined information 130 is displayed in a pop-up window or as a banner advertisement on the display 110, this is exemplary and thus the predetermined information 130 may be displayed in any part of a virtual space of the game. For example, the part of the virtual space may be a building board or sign board in the game.

In another embodiment, the predetermined information 130 may include sound information or physical haptic information. Also, the predetermined information 130 may include various pieces of information such as an advertisement, news in the game, activities of other users, etc.

While the predetermined information is output in the absence of a user input for 5 seconds in FIG. 2, this is purely exemplary. The time period during which there is no user input may be changed according to the type of the predetermined information, the state of an on-going application, etc.

The user input may include one or more of a touch input, push of a physical button, tilting, and displacement. Referring to FIG. 2, although a physical button 120 is positioned at a bottom end of the display 110, the physical button 120 may be disposed at a top end of the information providing apparatus 1 or on the rear or side surface of the information providing apparatus 1.

In the case of a game that is executed by receiving a user input through tilting of the information providing apparatus 1, the predetermined information may be provided in the absence of tilting for a predetermined time. For this purpose, the user input recognizer 10 may include a tilting sensor such as a gyro sensor.

The information providing apparatus 1 may further include a sensor such as a touch screen, a touchpad, an accelerometer, a physical button, etc.

The user input may be any input applied to the information providing apparatus 1 or an input applied for a specific function of an on-going application in the information providing apparatus 1. For example, if the on-going application is a Roll Playing Game (RPG) and only a move command for a character of a user is determined to be the user input, the predetermined information may be provided even though there is a user input for building an RPG building or manipulating a game setting, for a predetermined time. That is, upon elapse of a predetermined time during which the user is not involved in the application, the predetermined information may be output. Further, the predetermined information may be output only in a part of an area in which the application is being executed or on a full screen.

The predetermined information may be, but not limited to, an advertisement or additional information about the on-going application in information providing apparatus 1. The advertisement may be an advertisement image or video provided by an advertiser. Also, the additional information may include notification information for users using the on-going application.

Upon recognition of a user input during output of the predetermined information, the controller 20 may discontinue outputting the predetermined information. Since the predetermined information is provided to the user in the absence of a user input, if a user input is applied again, the predetermined information needs to disappear. For example, a plurality of pieces of predetermined information may be provided. The plurality of pieces of predetermined information may appear and disappear sequentially.

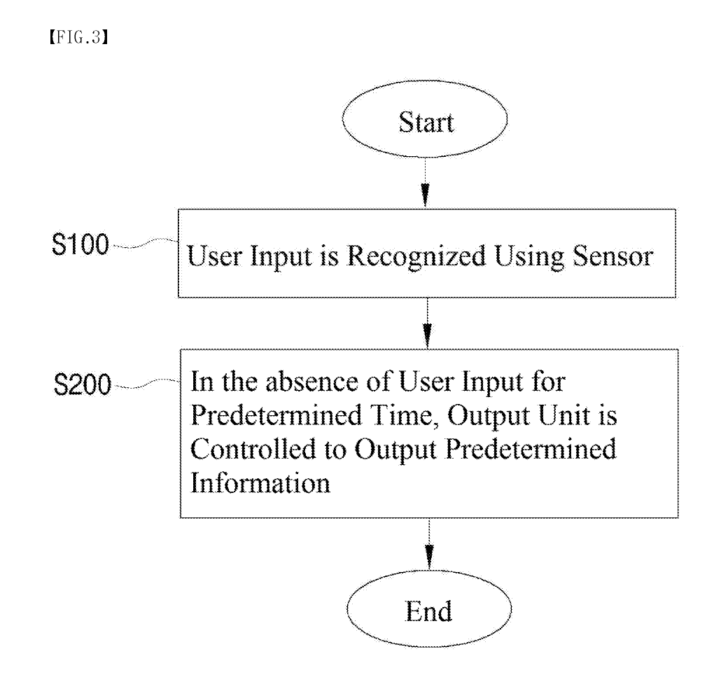

FIG. 3 is a flowchart illustrating a method for providing information based on the presence or absence of a user input according to an embodiment of the present invention. The method for providing information based on the presence or absence of a user input includes recognizing a user input using a sensor (S100), and controlling an output unit to output predetermined information, if a user input is not recognized for a predetermined time (S200). The outputting of the predetermined information may be performed using one or more of a speaker, a display, and a vibrator. Further, the predetermined information may be an advertisement or additional information about an application being executed in the information providing apparatus.

The controlling of the output unit may include, if a user input for the on-going application is not recognized, controlling output of the predetermined information to a part of an area in which the application is being executed. The method may further include, upon recognition of a user input during output of the predetermined information, discontinuing outputting the predetermined information.

The method may be executed in an apparatus for providing information based on the presence or absence of a user input.

Further, a program according to an embodiment of the present invention may include commands for executing the above-described method for providing information in the presence or absence of a user input.

According to another embodiment of the present invention, a computer-recordable storage medium may store the above program.

As is apparent from the foregoing description, the present invention advantageously enables a user to concentrate on an application such as a game by selectively providing predetermined information such as an advertisement, etc. Further, an advertisement may be exposed more efficiently to a user.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. An apparatus for providing information based on the presence or absence of a user input, the apparatus comprising:
a user input recognizer configured to recognize a user input; and
a controller configured to, if a user input is not recognized for a predetermined time, control an output unit to output predetermined information.

2. The apparatus according to claim 1, wherein the output unit includes at least one of a speaker, a display, and a vibrator.

3. The apparatus according to claim 1, further comprising the output unit.

4. The apparatus according to claim 1, wherein the predetermined information includes an advertisement or additional information about an application being executed in the apparatus.

5. The apparatus according to claim 1, wherein the user input recognizer includes at least one of a touch screen, a touchpad, a physical button, an accelerometer, and a gyro sensor, to receive the user input.

6. The apparatus according to claim 1, wherein if a user input for an application being executed is not recognized, the controller controls output of the predetermined information to a part of an area in which the application is being executed.

7. The apparatus according to claim 6, wherein the application being executed in the apparatus is a game.

8. The apparatus according to claim 1, wherein upon recognition of a user input while the predetermined information is output, the controller discontinues outputting the predetermined information.

9. A method for providing information based on the presence or absence of a user input, the method comprising:
recognizing a user input using a sensor; and
if a user input is not recognized for a predetermined time, controlling an output unit to output predetermined information.

10. The method according to claim 9, wherein the outputting of predetermined information comprises outputting the predetermined information using at least one of a speaker, a display, and a vibrator.

11. The method according to claim 9, wherein the predetermined information includes an advertisement or additional information about an application being executed in an apparatus.

12. The method according to claim 9, wherein the controlling of the output unit comprises, if a user input for an application being executed is not recognized, controlling output of the predetermined information to a part of an area in which the application is being executed.

13. The method according to claim 9, further comprising, upon recognition of a user input while the predetermined information is output, discontinuing outputting the predetermined information.

14. A computer program including a command to perform the method according to claim 9.
